(19) United States
(12) Patent Application Publication
(10) Pub. No.: US 2025/0368538 A1
(43) Pub. Date: Dec. 4, 2025

(54) METAL COMPOSITE COMPOUND AND CATHODE ACTIVE MATERIAL INCLUDING METAL COMPOSITE COMPOUND AS PRECURSOR

(71) Applicant: TANAKA CHEMICAL CORPORATION, Fukui (JP)

(72) Inventor: Kenta OZAWA, Fukui (JP)

(73) Assignee: TANAKA CHEMICAL CORPORATION, Fukui (JP)

(21) Appl. No.: 19/300,017

(22) Filed: Aug. 14, 2025

Related U.S. Application Data
(63) Continuation of application No. PCT/JP2024/000916, filed on Jan. 16, 2024.

(30) Foreign Application Priority Data
Feb. 16, 2023 (JP) 2023-022394

(51) Int. Cl. C01G 53/506

(52) U.S. Cl. CPC C01G 53/506; C01P 2002/60; C01P 2004/51; C01P 2004/61; C01P 2006/10; C01P 2006/11; C01P 2006/12; C01P 2006/40

(57) ABSTRACT

The present disclosure relates to a metal composite compound including at least nickel (Ni) and boron (B), wherein, at a molar ratio of lithium (Li) to a metal element (M) in the metal composite compound (Li/M) of 1.01, a calcined product of the metal composite compound, maintained for a predetermined time at a calcination temperature of 730° C. in an oxygen atmosphere, exhibits a β value of 300.0 or less in a fitting function Y=α×log₁₀ X +β that is a semi-logarithmic graph of time T and a crystallite size S1, with the common logarithm of the time T (unit: minutes) for maintaining the metal composite compound at a calcination temperature of 730° C. on the X-axis and the crystallite size S1 of the (003) plane (unit: Å) on the Y-axis.

### CROSS REFERENCE TO RELATED APPLICATIONS

This is a continuation application of International Patent Application No. PCT/JP2024/000916 filed Jan. 16, 2024, which claims the benefit of Japanese Patent Application No. 2023-022394 filed Feb. 16, 2023, and the full contents of all of which are hereby incorporated by reference in their entirety.

### BACKGROUND

### Technical Field

The present disclosure relates to a metal composite compound and a cathode active material including the metal composite compound as a precursor, and particularly to a metal composite compound that contains at least nickel (Ni) and boron (B), thereby enabling the production of a cathode active material with high capacity retention rates, and a cathode active material including the metal composite compound as a precursor.

### Description of the Related Art

In recent years, secondary batteries have been used in a wide range of fields, such as portable devices and vehicles using or combining electricity as a power source, in order to reduce the environmental burden. Secondary batteries include, for example, lithium-ion secondary batteries or the like using nonaqueous electrolytes. Secondary batteries using non-aqueous electrolytes, such as lithium-ion secondary batteries, are suitable for miniaturization and weight reduction, and have characteristics such as high utilization and high cycle characteristics.

For the cathode active material of the lithium-ion secondary battery, cycle characteristics deteriorate due to repeated charge-discharge cycles, resulting in the problem of reduced performance of the lithium-ion secondary battery. Therefore, cathode active materials that can prevent degradation of battery performance in spite of repeated charge-discharge cycles of the lithium-ion secondary battery are being investigated.

As a cathode active material capable of preventing degradation of battery performance in spite of repeated charge-discharge cycles, a cathode active material has been proposed, which is prepared by coating the surface of lithium transition metal oxide with lithium boron oxide by dry mixing and further heat treating, lithium transition metal oxide obtained by mixing and then calcining a resulting nickel-containing precursor for a cathode active material with a lithium compound, with a boron-containing compound (National Publication of International Patent Application No. 2015-536558).

In Patent Literature 1, lithium impurities on lithium transition metal oxide are converted to structurally stable lithium boron oxide to prevent changes in the cathode active material over time.

However, with the cathode active material of National Publication of International Patent Application No. 2015-536558, the cycle characteristics of the cathode active material still tended to deteriorate with repeated charge-discharge cycles, and there was room for improving cycle characteristics.

### SUMMARY

The present disclosure is related to providing a metal composite compound as a precursor of a cathode active material, capable of preventing deterioration of cycle characteristics of the cathode active material in spite of repeated charge-discharge cycles of the secondary battery, and a cathode active material including the metal composite compound as a precursor.

The metal composite compound of the present disclosure is secondary particles formed by agglomeration of the primary particles. The inclusion of boron (B) in the metal composite compound of the present disclosure controls the crystallite size of the cathode active material including the metal composite compound as a precursor, and also suppresses sintering of the primary particles constituting the metal composite compound during production of the cathode active material.

According to an aspect of the present disclosure, a metal composite compound comprising at least nickel (Ni) and boron (B),
wherein, at a molar ratio of lithium (Li) to a metal element (M) in the metal composite compound (Li/M) of 1.01, a calcined product of the metal composite compound, maintained for a predetermined time at a calcination temperature of 730° C. in an oxygen atmosphere, exhibits a β value of 300.0 or less in a fitting function Y=α×log₁₀ X+β that is a semi-logarithmic graph of time T and a crystallite size S1, with the common logarithm of the time T (unit: minutes) for maintaining the metal composite compound at a calcination temperature of 730° C. on the X-axis and the crystallite size S1 of the (003) plane (unit: Å) on the Y-axis.

In one embodiment of the present disclosure, a content of nickel (Ni) to the total amount of the metal element (M) is 80 mol % or more.

In one embodiment of the present disclosure, a content of boron (B) to the total amount of the metal element (M) is more than 0 mol % and 1.0 mol % or less.

In one embodiment of the present disclosure, an a value of Y=α×log₁₀ X+β is 40.0 or less.

In one embodiment of the present disclosure, the metal composite compound has a crystallite size S2 of the (001) plane of 153.0 Å or less.

In one embodiment of the present disclosure, the metal composite compound is a transition metal-containing hydroxide further comprising at least one additive element selected from the group consisting of cobalt (Co) and manganese (Mn).

In one embodiment of the present disclosure, the metal composite compound has a BET specific surface area of 24.0 m²/g or more.

In one embodiment of the present disclosure, the metal composite compound has a tap density of 1.50 g/ml or less.

In one embodiment of the present disclosure, the metal composite compound has a bulk density of 1.10 g/ml or less.

In one embodiment of the present disclosure, the metal composite compound

is a precursor of a cathode active material of a non-aqueous electrolyte secondary battery.

According to another aspect of the present disclosure, a cathode active material of a non-aqueous electrolyte secondary battery, wherein the cathode active material is formed by calcining the metal composite compound with a lithium compound.

The β value of the fitting function Y=α×log₁₀ X+β refers to the crystallite size S1 of the (003) plane derived from the metal composite compound at a time T of 0, for maintaining the metal composite compound at a calcination temperature of 730° C. When the β value is 300.0 or less, the crystallite size S1 of the (003) plane derived from the metal composite compound decreases, and the size of the primary particles constituting the metal composite compound tends to be smaller.

According to the metal composite compound of the present disclosure, at a molar ratio of lithium (Li) to a metal element (M) in the metal composite compound (Li/M) of 1.01, a calcined product of the metal composite compound, maintained for a predetermined time at a calcination temperature of 730° C. in an oxygen atmosphere, exhibits a β value of 300.0 or less in a fitting function Y=α×log₁₀ X+β that is a semi-logarithmic graph of time T and crystallite size S1, with the common logarithm of time T (unit: minutes) for maintaining the metal composite compound at a calcination temperature of 730° C. on the X-axis and the crystallite size S1 of the (003) plane (unit: Å) on the Y-axis; and since the β value is 300.0 or less, sintering of the primary particles constituting the metal composite compound is inhibited when a cathode active material is prepared from the metal composite compound, and thus the formation of microcracks in the cathode active material due to charge-discharge cycles is suppressed. As described above, according to the metal composite compound of the present disclosure, the formation of microcracks in the cathode active material prepared from the metal composite compound due to charge-discharge cycles is suppressed, and thus deterioration of cycle characteristics of the cathode active material can be prevented in spite of repeated charge-discharge cycles of the secondary battery.

According to the metal composite compound of the present disclosure, when the content of boron (B) to the total amount of the metal element (M) is more than 0 mol % and 1.0 mol % or less, sintering of the primary particles constituting the metal composite compound can be more effectively suppressed, and the deterioration of cycle characteristics of the cathode active material can be more effectively prevented.

According to the metal composite compound of the present disclosure, when a value of the fitting function Y=α×log₁₀ X+β is 40.0 or less, sintering of the primary particles constituting the metal composite compound can be more effectively suppressed when a cathode active material is prepared from the metal composite compound, and the deterioration of cycle characteristics of the cathode active material can be more effectively prevented.

According to the metal composite compound of the present disclosure, when the metal composite compound has a crystallite size S2 of the (001) plane of 153.0 Å or less, sintering of the primary particles constituting the metal composite compound can be more effectively suppressed, and the deterioration of cycle characteristics of the cathode active material can be more effectively prevented.

### BRIEF DESCRIPTION OF DRAWINGS

FIG. 1 is an image of a cross-section of a cathode active material including a metal composite compound as a precursor, obtained by a scanning electron microscope (20,000× magnification).

### DETAILED DESCRIPTION

Hereinafter, the metal composite compound of the present disclosure comprising at least nickel (Ni) and boron (B) will be described in detail. The metal composite compound of the present disclosure comprising at least nickel (Ni) and boron (B) (hereinafter may be simply referred to as “the metal composite compound of the present disclosure”) is secondary particles formed by agglomeration of the primary particles. The shape of the particles of the metal composite compound of the present disclosure comprising at least nickel (Ni) and boron (B) is not particularly limited, and may include various shapes, such as a substantially spherical or substantially ellipsoidal shape.

In the metal composite compound of the present disclosure comprising at least nickel (Ni) and boron (B), at a molar ratio of lithium (Li) to a metal element (M) in the metal composite compound (Li/M) of 1.01, a calcined product of the metal composite compound, maintained for a predetermined time at a calcination temperature of 730° C. in an oxygen atmosphere, exhibits a β value of 300.0 or less in a fitting function Y=α×log₁₀ X+β that is a semi-logarithmic graph of time T and crystallite size S1, with the common logarithm of time T (unit: minutes) for maintaining the metal composite compound at a calcination temperature of 730° C. on the X-axis and the crystallite size S1 of the (003) plane (unit: A) on the Y-axis. In the metal composite compound of the present disclosure, the β value, which is the y-intercept in the above fitting function (i.e., the time T for maintaining the metal composite compound at a calcination temperature of 730° C. being 0 minutes), is adjusted to 300.0 or less.

Since the β value of the above fitting function is 300.0 or less, the metal composite compound of the present disclosure exhibits, in an embodiment, a reduced crystallite size S1 of the (003) plane of the metal composite compound when starting calcination of the metal composite compound and a lithium compound at a calcination temperature of 730° C. In an embodiment where the crystallite size S1 of the (003) plane is reduced, the size of the primary particles constituting the metal composite compound tends to be smaller. A calcination temperature of 730° C. falls within the range of calcination temperatures commonly used to obtain a cathode active material from a metal composite compound and a lithium compound.

The fitting function Y=α×log₁₀ X+β is determined by plotting the common logarithm of time T during which the metal composite compound of the present disclosure is maintained at a calcination temperature of 730° C. on the X-axis and the crystallite size S1 of the (003) plane when the metal composite compound is maintained at a calcination temperature of 730° C. for time T on the Y-axis, and by a least squares method from multiple plots corresponding to various time points T1, T2, T3, etc., maintained at a calcination temperature of 730° C. The temperature increase rate up to a calcination temperature of 730° C. is 120° C./hour. The holding time T for calcination at 730° C. is in the range of 0 minutes to 600 minutes.

As the metal composite compound of the present disclosure exhibits a β value of the above fitting function of 300.0 or less, sintering of the primary particles constituting the metal composite compound is inhibited to suppress the enlargement of the particle size of the primary particles when a cathode active material is prepared from the metal composite compound, and thus the formation of microcracks in the cathode active material due to charge-discharge cycles is suppressed. As described above, according to the metal composite compound of the present disclosure, the formation of microcracks in the cathode active material formed from the metal composite compound due to charge-discharge cycles is suppressed, and thus high capacity retention rates can be maintained in spite of repeated charge-discharge cycles of the secondary battery, and as a result, deterioration of cycle characteristics of the cathode active material can be prevented.

The β value of the above fitting function is not particularly limited as long as it is 300.0 or less. To achieve a high capacity retention rate effectively, the upper limit value of the β value is preferably 290.0, more preferably 280.0 and particularly preferably 270.0. On the other hand, the lower limit value of the β value of the above fitting function is preferably 180.0, and particularly preferably 190.0 in terms of achieving a high capacity retention rate effectively while preventing an increase in boron (B) usage. The β value of the above fitting function may be controlled by adjusting the content of nickel (Ni) and boron (B) of the metal composite compound. The above upper limit value and lower limit value may be optionally combined.

The α value corresponding to the slope of the above fitting function indicates the degree of increase in the crystallite size S1 of the (003) plane depending on calcination progress to obtain the cathode active material from the metal composite compound. Although the α value of the above fitting function is not particularly limited, the upper limit value is preferably 40.0, more preferably 39.0 from the viewpoint that even if the calcination process to obtain the cathode active material from the metal composite compound proceeds, sintering of the primary particles constituting the metal composite compound is more effectively suppressed and the capacity retention rate of the cathode active material is further enhanced to prevent the deterioration of cycle characteristics more effectively. The upper limit value is further preferably 35.0 and particularly preferably 30.0 from the viewpoint of further enhancing the capacity retention rate of the cathode active material. On the other hand, the lower limit value of the α value of the above fitting function is preferably 15.0, and particularly preferably 20.0 in terms of achieving a high capacity retention rate effectively while preventing an increase in boron (B) usage. The α value of the above fitting function may be controlled by adjusting the content of nickel (Ni) and boron (B) of the metal composite compound. The above upper limit value and lower limit value may be optionally combined.

The crystallite size S2 of the (001) plane of the metal composite compound of the present disclosure is not particularly limited, and the upper limit value is preferably 153.0 Å, and particularly preferably 151.0 Å from the viewpoint that the sintering of the primary particles constituting the metal composite compound is more effectively suppressed when a cathode active material is prepared and the capacity retention rate of the cathode active material is further enhanced to prevent the deterioration of cycle characteristics more effectively. On the other hand, the lower limit value of the crystallite size S2 of the (001) plane of the metal composite compound is preferably 100.0 Å and particularly preferably 120.0 Å in terms of achieving a high capacity retention rate effectively while preventing an increase in boron (B) usage. The above crystallite size S2 of the (001) plane of the metal composite compound may be controlled by adjusting the content of nickel (Ni) and boron (B) of the metal composite compound. The above upper limit value and lower limit value may be optionally combined.

The composition of the metal composite compound of the present disclosure is not particularly limited, as long as the metal composite compound comprises nickel (Ni) and boron (B). In other words, the metal composite compound of the present disclosure comprises nickel (Ni) and boron (B) as essential components.

The nickel content in the metal composite compound of the present disclosure is not particularly limited, and the lower limit value is preferably 80 mol %, and particularly preferably 82 mol % relative to the total amount of the metal element (M) in the metal composite compound from the viewpoint that the raw material cost can be reduced while obtaining a cathode active material with high utilization rates, high cycle characteristics and improved physical properties such as charge-discharge efficiency. On the other hand, the upper limit value of the nickel content in the metal composite compound of the present disclosure is 100 mol %, preferably 95 mol % and particularly preferably 90 mol % relative to the total amount of the metal element (M) in the metal composite compound in order to effectively obtain a cathode active material with high utilization rates, high cycle characteristics and improved physical properties such as charge-discharge efficiency. The above upper limit value and lower limit value may be optionally combined.

The boron content in the metal composite compound of the present disclosure is more than 0 mol % relative to the total amount of the metal element (M) in the metal composite compound. The lower limit value of the boron content is preferably 0.1 mol %, more preferably 0.2 mol %, and particularly preferably 0.3 mol % relative to the total amount of the metal element (M) in the metal composite compound from the viewpoint of effectively adjusting the β value of the above fitting function to 300.0 or less, and more effectively suppressing sintering of the primary particles constituting the metal composite compound, and further enhancing the capacity retention rate of the cathode active material to prevent the deterioration of cycle characteristics more effectively. On the other hand, the upper limit value of the boron content is preferably 1.0 mol %, and particularly preferably 0.9 mol % relative to the total amount of the metal element (M) in the metal composite compound from the viewpoint of effectively adjusting the β value of the above fitting function to 300.0 or less while preventing an increase in boron (B) usage. The above upper limit value and lower limit value may be optionally combined.

The metal composite compound of the present disclosure includes a transition metal-containing hydroxide comprising at least nickel (Ni) and boron (B). The composition of the metal composite compound of the present disclosure also includes a transition metal-containing hydroxide comprising at least one additive element selected from the group consisting of cobalt (Co) and manganese (Mn). In short, the metal composite compound of the present disclosure includes a transition metal-containing hydroxide comprising nickel (Ni) and boron (B) and at least one additive element selected from the group consisting of cobalt (Co) and manganese (Mn).

The molar ratio Ni:Co:Mn in the transition metal-containing hydroxide comprising nickel (Ni) and boron (B) and at least one additive element selected from the group consisting of cobalt (Co) and manganese (Mn) may be, for example, 1-x-y:x:y (0<x≤0.15, 0<y≤0.05).

The transition metal-containing hydroxide comprising nickel (Ni) and boron (B) and at least one additive element selected from the group consisting of cobalt (Co) and manganese (Mn) may also include one or more additional additive elements selected from the group consisting of Al, Fe, Ti, Mg, Ca, Sr, Ba, V, Nb, Cr, Mo, W, Ru, Cu, Zn, Ga, Si, Sn, P, Bi and Zr. Nickel (Ni), at least one additive element selected from the group consisting of cobalt (Co) and manganese (Mn) (the first optional components), and one or more additional additive elements selected from the group consisting of Al, Fe, Ti, Mg, Ca, Sr, Ba, V, Nb, Cr, Mo, W, Ru, Cu, Zn, Ga, Si, Sn, P, Bi and Zr (the second optional components) constitute the metal element (M) in the metal composite compound.

The BET specific surface area of the metal composite compound of the present disclosure is not particularly limited, and the lower limit value of the BET specific surface area is preferably 24.0 m²/g from the viewpoint that the sintering of the primary particles constituting the metal composite compound is more effectively suppressed, thereby contributing to improved capacity retention rate of the cathode active material. On the other hand, the upper limit value of the BET specific surface area of the metal composite compound of the present disclosure is preferably 40.0 m²/g, more preferably 35.0 m²/g, and particularly preferably 30.0 m²/g from the viewpoint of an increase in the crush strength of the cathode active material while contributing to improved capacity retention rate of the cathode active material. The above upper limit value and lower limit value may be optionally combined.

The tap density (TD) of the metal composite compound of the present disclosure is not particularly limited, and the upper limit value of the tap density (TD) is preferably 1.50 g/ml, more preferably 1.40 g/ml, and particularly preferably 1.35 g/ml from the viewpoint that the sintering of the primary particles constituting the metal composite compound is more effectively suppressed, thereby contributing to improved capacity retention rate of the cathode active material. On the other hand, the lower limit value of the tap density (TD) of the metal composite compound of the present disclosure is preferably 1.00 g/ml, and particularly preferably 1.10 g/ml from the viewpoint of improved packing density of the cathode active material in the cathode. The above upper limit value and lower limit value may be optionally combined.

The bulk density (BD) of the metal composite compound of the present disclosure is not particularly limited, and the upper limit value of the bulk density (BD) is preferably 1.10 g/ml, more preferably 1.05 g/ml, and particularly preferably 1.00 g/ml from the viewpoint that the sintering of the primary particles constituting the metal composite compound is more effectively suppressed, thereby contributing to improved capacity retention rate of the cathode active material. On the other hand, the lower limit value of the bulk density (BD) of the metal composite compound of the present disclosure is preferably 0.70 g/ml, and particularly preferably 0.80 g/ml from the viewpoint of improved packing density of the cathode active material in the cathode. The above upper limit value and lower limit value may be optionally combined.

The particle size of the metal composite compound of the present disclosure is not particularly limited, and the upper limit value of the secondary particle size at a cumulative volume percentage of 50% (hereinafter sometimes simply referred to as “D50”) is preferably 15.0 μm, more preferably 13.0 μm, and particularly preferably 11.0 um from the viewpoint of improving contact with the electrolyte. On the other hand, the lower limit value of D50 of the metal composite compound of the present disclosure is preferably 6.0 μm, and particularly preferably 8.0 μm from the viewpoint of improved packing density of the cathode active material in the cathode. The above upper limit value and lower limit value may be optionally combined.

The upper limit value of the secondary particle size at a cumulative volume percentage of 10% (hereinafter sometimes simply referred to as “D10”) of the metal composite compound of the present disclosure is preferably 10.0 μm, particularly preferably 8.0 μm from the viewpoint of improving contact with the electrolyte. On the other hand, the lower limit value of D10 of the metal composite compound of the present disclosure is preferably 4.0 μm, and particularly preferably 5.0 μm from the viewpoint of improved packing density of the cathode active material in the cathode. The above upper limit value and lower limit value may be optionally combined.

The upper limit value of the secondary particle size at a cumulative volume percentage of 90% (hereinafter sometimes simply referred to as “D90”) of the metal composite compound of the present disclosure is preferably 20.0 um, particularly preferably 17.0 μm from the viewpoint of improving contact with the electrolyte. On the other hand, the lower limit value of D90 of the metal composite compound of the present disclosure is preferably 12.0 μm, and particularly preferably 14.0 μm from the viewpoint of improved packing density of the cathode active material in the cathode. The above upper limit value and lower limit value may be optionally combined. D50, D10, and D90 described above refer to particle sizes measured by a particle size distribution measurement device using a laser diffraction scattering method.

The metal composite compound of the present disclosure may be used as a precursor of a cathode active material of a non-aqueous electrolyte secondary battery such as lithium ion secondary batteries.

Next, the method for producing a metal composite compound of the present disclosure will be described. The method for producing a metal composite compound of the present disclosure includes a crystallization step. The crystallization step refers to a step of in which an aqueous solution including a nickel salt and a boron-containing compound and an aqueous solution containing a complexing agent are added and mixed in a reaction tank, and a pH adjuster is supplied to the reaction solution in the reaction tank to maintain the pH of the reaction solution in the reaction tank at pH 9 or more and 13 or less based on a liquid temperature of 40° C. to perform co-precipitation reaction in the reaction solution, thereby obtaining particles of a nickel-containing hydroxide.

More specifically, according to the co-precipitation method, a solution containing a complexing agent and a pH adjuster are added to a mixed solution (a raw material solution) containing a nickel salt (e.g., a sulfate), a boron-containing compound (e.g., boric acid), and if necessary, a cobalt salt (e.g., a sulfate), a manganese salt (e.g., a sulfate), etc., and by stirring the mixed solution (reaction solution) in the reaction tank, the reaction solution is neutralized and crystallized in the reaction tank to prepare particles of the metal composite compound containing at least nickel and boron, thereby obtaining a suspension in the form of slurry including the particles of the metal composite compound containing at least nickel and boron. Water, for example, is used as a solvent for the suspension. Thus, the raw material solution is an aqueous solution containing a nickel salt (e.g., a sulfate) and a boron-containing compound. The solution containing a complexing agent may be an aqueous solution of a complexing agent.

The complexing agent is not particularly limited, provided it can form complexes with nickel ions, boron ions (and, if necessary, cobalt ions, manganese ions, etc.) in an aqueous solution. Examples thereof include an ammonium ion source. Examples of ammonium ion sources include ammonium sulfate, ammonium chloride, ammonium carbonate and ammonium fluoride.

In the co-precipitation reaction, a pH adjuster is added if necessary as described above in order to adjust the pH of the reaction solution in the reaction tank to a range of 9 or more and 13 or less based on a liquid temperature of 40° C., preferably to a range of 10 or more and 13 or less based on a liquid temperature of 40° C. Examples of pH adjusters include an alkaline metal hydroxide (such as sodium hydroxide and potassium hydroxide).

Furthermore, in the co-precipitation reaction, the temperature of the reaction tank is controlled for example, within a range of 10° C. to 80° C., and preferably 20 to 70° C.

Examples of the reaction tank used in the method for producing a metal composite compound of the present disclosure include a continuous reaction tank that overflows metal composite compound particles from an overflow pipe to separate the obtained metal composite compound and recover the metal composite compound particles as a product, and a batch reaction tank that does not discharge transition metal-containing hydroxide particles outside the system until the reaction is complete.

A semi-batch reactor may also be used as the reactor used in the method for producing a metal composite compound of the present disclosure. The semi-batch reactor has a continuous reaction tank to which one end of an overflow pipe is connected, a sedimentation tank to which another end of the overflow pipe is connected, and a recovery pipe connecting the bottom of the sedimentation tank and the continuous reaction tank. A slurry containing the metal composite compound particles overflows from an overflow pipe installed in the continuous reaction tank and is transferred to the sedimentation tank. The slurry containing the metal composite compound particles, which is transferred to the sedimentation tank, undergoes sedimentation of the metal composite compound particles to the lower part of the sedimentation tank by gravity, forming a concentrated slurry of the metal composite compound particles. The concentrated slurry of the metal composite compound particles formed in the lower part of the sedimentation tank is returned to the continuous reaction tank through a recovery pipe. When the concentrated slurry is formed, a supernatant solution is formed in the upper part of the sedimentation tank, and the supernatant solution is discharged outside through a discharge pipe. In the semi-batch reactor, by returning the metal composite compound particles to the continuous reaction tank from the sedimentation tank, the nuclear growth of metal composite compound particles is promoted, thereby enabling the particle size distribution of the metal composite compound particles to be made uniform.

After the co-precipitation reaction is complete in the continuous reaction tank, the obtained metal composite compound particles are filtered from the slurry, and then washed with water and dried to give the metal composite compound of the present disclosure.

Next, a cathode active material of a non-aqueous electrolyte secondary battery including the metal composite compound of the present disclosure as a precursor (hereinafter may be simply referred to as a “cathode active material”) will be described. The cathode active material is formed by calcining the metal composite compound of the present disclosure, which serves as a precursor, with a lithium compound in one embodiment. The cathode active material has a layered crystal structure, and from the viewpoint of obtaining a secondary battery with high discharge capacity, a trigonal crystal structure, a hexagonal crystal structure, or a monoclinic crystal structure is preferred.

The cathode active material including the metal composite compound of the present disclosure as a precursor may be used as a cathode active material of a non-aqueous electrolyte secondary battery such as lithium ion secondary batteries.

Next, the method for producing a cathode active material including the metal composite compound of the present disclosure as a precursor will be described. For example, in the method for producing a cathode active material including the metal composite compound of the present disclosure as a precursor, first a lithium compound is added to the metal composite compound of the present disclosure to prepare a mixture of the metal composite compound of the present disclosure and the lithium compound. The lithium compound is not particularly limited, provided that the compound includes lithium, and examples thereof include lithium carbonate, lithium hydroxide, lithium nitrate, lithium acetate, lithium oxalate and halogenated lithium. The quantity of the lithium compound incorporated may be appropriately selected to obtain a cathode active material with the desired lithium composition.

Then the above mixture is calcined to produce the cathode active material. The calcination condition includes, for example, a calcination temperature of 600°° C. or more and 1,000° C. or less, a temperature-increasing rate of 50° C./hour or more and 300° C./hour or less, and a calcination time of 5 hours or more and 20 hours or less. Examples of the calcination atmosphere include air, oxygen, and the like. The calcination furnace used for calcination is not particularly limited, but examples thereof include a stationary box furnace, a roller hearth continuous furnace, and the like.

Next, a cathode using the cathode active material including the metal composite compound of the present disclosure as a precursor will be described. A cathode has a cathode current collector and a cathode active material layer using a cathode active material formed on the surface of the cathode current collector. The cathode active material layer includes a cathode active material, a binder and a conductive auxiliary. The conductive auxiliary is not particularly limited, provided that the conductive auxiliary can be used for non-aqueous electrolyte secondary batteries, and for example, a carbon material may be used. Examples of carbon materials include graphite powder, carbon black (e.g., acetylene black) and a fibrous carbon material. The binder is not particularly limited, and examples thereof include a polymer resin such as polyvinylidene fluoride (PVdF), butadiene rubber (BR), polyvinyl alcohol (PVA), carboxymethylcellulose (CMC) and polytetrafluoroethylene (PTFE), and a combination thereof. The cathode current collector is not particularly limited, and for example, a foil member formed from a metal material such as Al, Ni, stainless steel or the like may be used. Among them, from the viewpoint of ease of processing and low cost, a current collector formed from aluminum and processed into a thin foil is preferred.

In the method for producing a cathode, first a cathode active material slurry is prepared by mixing a cathode active material, a conductive auxiliary and a binder. Next, the cathode active material slurry is applied to the cathode current collector by a known filling method, dried and pressed to adhere to the cathode current collector, and a cathode can be obtained.

By incorporating a cathode using the cathode active material obtained as described above, an anode (comprising an anode current collector and an anode active material layer including an anode active material formed on the surface of the anode current collector), an electrolyte solution containing predetermined electrolytes and a separator by a known method, a non-aqueous electrolyte secondary battery can be assembled.

Examples of electrolytes in the electrolyte solution include a lithium salt such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, Li₂B₁₀Cl₁₀, LiBOB (in which BOB refers to bis(oxalato)borate), LiFSI (in which FSI refers to bis(fluorosulfonyl)imide), lower aliphatic lithium carboxylate and LiAlCl₄. These lithium salts may be used singly or two or more of them may be used in combination.

As a dispersion medium of electrolyte, for example, a carbonate such as propylene carbonate, ethylene carbonate, dimethyl carbonate, diethyl carbonate, ethyl methyl carbonate, 4-trifluoromethyl-1,3-dioxolan-2-one, and 1,2-di (methoxycarbonyloxy) ethane; an ether such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; an ester such as methyl formate, methyl acetate and γ-butyrolactone; a nitrile such as acetonitrile and butyronitrile; an amide such as N,N-dimethylformamide and N,N-dimethylacetamide; a carbamate such as 3-methyl-2-oxazolidone; a sulfur-containing compound such as sulfolane, dimethyl sulfoxide and 1,3-propanesultone, or an organic solvent into which fluoro groups are introduced (an organic solvent in which one or more hydrogen atoms are substituted with a fluorine atom) may be used. These dispersion media may be used singly or two or more of them may be used in combination.

A solid electrolyte may also be used instead of the electrolyte solution containing electrolyte. Examples of solid electrolytes include an organic polyelectrolyte such as a polyethylene oxide polymer compound and a polymer compound including at least one polyorganosiloxane chain or polyoxyalkylene chain. What is called a gel-type polymer electrolyte, comprising a polymer compound retaining a non-aqueous electrolyte, may also be used. Examples also include an inorganic solid electrolyte containing a sulfide, such as Li₂S—SiS₂, Li₂S—GeS₂, Li₂S—P₂S₅, Li₂S—B₂S₃, Li₂S—SiS₂—Li₃PO₄, Li₂S—SiS₂—Li₂SO₄ and Li₂S—GeS₂—P₂S₅. These may be used singly or two or more of them may be used in combination.

Examples of separators include a member in the form of a porous film, a nonwoven fabric or a woven fabric, which is formed from a material such as a polyolefin resin including polyethylene and polypropylene, a fluororesin or a nitrogen-containing aromatic polymer.

### EXAMPLES

Next, Examples of the metal composite compound of the present disclosure will be described, but the present disclosure is not limited to these examples, provided it does not depart from the subject matter of the invention.

### Production of Metal Composite Compound of Examples and Comparative Examples

### Production of Metal Composite Compound of Example 1

Nickel sulfate, cobalt sulfate and manganese sulfate were dissolved at a molar ratio of nickel:obalt:manganese of 83.0:12.1:4.9. Then an aqueous solution in which boric acid was dissolved (a raw material solution) to achieve a boron concentration of 0.4 mol % relative to the total amount of nickel, cobalt and manganese, an aqueous ammonium sulfate solution (an ammonium ion source), and an aqueous sodium hydroxide solution were supplied to a reaction tank of a semi-batch reactor. The mixed solution was continuously stirred by a stirrer equipped with a stirring blade while maintaining the pH of the mixed solution in the reaction tank at 10.2 based on a liquid temperature of 40° C. and maintaining the ammonium concentration at 1.0 g/L. The reaction tank was maintained under a nitrogen atmosphere. The temperature of the mixed solution in the reaction tank was kept at 60.0° C. The holding time of the metal composite compound crystallized by the neutralization reaction in the reaction tank was adjusted to 24.7 hours, and a slurry of the metal composite compound particles was obtained. The slurry of the metal composite compound particles obtained as described above was filtered, washed with an aqueous alkaline solution (an 8 wt % aqueous sodium hydroxide solution), and then subjected to solid-liquid separation. Thereafter, the separated solid phase was washed with water, subjected to dehydration and drying, and a metal composite compound in powdery form was obtained.

### Production of Metal Composite Compound of Example 2

A metal composite compound in powdery form was prepared in the same manner as in Example 1, except that an aqueous solution in which boric acid was dissolved to achieve a boron concentration of 0.9 mol % relative to the total amount of nickel, cobalt and manganese was used.

### Production of Metal Composite Compound of Example 3

A metal composite compound in powdery form was prepared in the same manner as in Example 1, except that an aqueous solution in which nickel sulfate, cobalt sulfate and manganese sulfate were dissolved at a molar ratio of nickel:cobalt:manganese of 88.0:9.0:3.0 was used.

### Production of Metal Composite Compound of Comparative Example 1

A metal composite compound in powdery form was prepared in the same manner as in Example 1, except that boric acid was not added to the raw material solution. Thus, in Comparative Example 1, the metal composite compound was free of boron.

### Production of Metal Composite Compound of Comparative Example 2

A metal composite compound in powdery form was prepared in the same manner as in Example 3, except that boric acid was not added to the raw material solution. Thus, in Comparative Example 2, the metal composite compound was free of boron.

### (1) Fitting Function Y=α×log₁₀ X+β

For the metal composite compounds of Examples 1 to 3 and Comparative Examples 1 and 2, using lithium hydroxide powder as a lithium compound, each of the metal composite compounds and lithium hydroxide powder were mixed at a molar ratio of lithium (Li) to a molar ratio of the metal elements (M, the total of nickel, cobalt, and manganese) contained in the metal composite compound, Li/M of 1.01. The mixture was maintained at a calcination temperature of 730° C. in an oxygen atmosphere for 30 minutes, 300 minutes, or 600 minutes to give a calcined product of the metal composite compound. For the obtained calcined product of the metal composite compound, a semi-logarithmic graph of time T and crystallite size S1 was prepared with the common logarithm of time T (i.e., 30 minutes, 300 minutes, and 600 minutes) for maintaining the metal composite compound at a calcination temperature of 730° C. on the X-axis and the crystallite size S1 of the (003) plane (unit: Å) of the calcined product of the metal composite compound at time T on the Y-axis. A fitting function Y=α×log₁₀ X+β was determined from the semi-logarithmic graph by a least squares method. The α value and the β value of the fitting function Y=α×log₁₀ X+β are shown in the following Table 1. The crystallite size S1 of the (003) plane was measured by an X-ray diffractometer (Ultima IV made by Rigaku Holdings Corporation).

The crystallite size S2 of the (001) plane of the metal composite compounds of Examples 1 to 3 and Comparative Examples 1 and 2 was measured by an X-ray diffractometer (Ultima IV made by Rigaku Holdings Corporation). The crystallite size S2 of the (001) plane is shown in the following Table 1.

TABLE 1

| | | | Crystallite size of |
|---|---|---|---|
| | α value | β value | (001) plane (Å) |
| Example 1 | 28.6 | 265.7 | 150.4 |
| Example 2 | 26.6 | 196.5 | 128.2 |
| Example 3 | 38.2 | 279.8 | 137.4 |
| Comparative | 47.2 | 300.2 | 170.9 |
| Example 1 | | | |
| Comparative | 38.2 | 394.3 | 155.8 |
| Example 2 | | | |

For the metal composite compounds of Examples 1 to 3 and Comparative Examples 1 and 2, the specific surface area (BET specific surface area), tap density, bulk density, D10, D50 and D90 were measured as follows.

### (2) Specific Surface Area (BET Specific Surface Area)

After deaerating 0.3 g of each of the metal composite compounds in nitrogen atmosphere at 105° C. for 30 minutes, the specific surface area was measured by the single point BET method using a specific surface area measurement device (Macsorb made by Mountech Co., Ltd.).

### (3) Tap Density

The tap density was measured by a tap denser (KYT-4000 made by SEISHIN Enterprise Co., Ltd.) by a constant volume measurement method. The measurement conditions for the tap density are as follows. Cell volume: 20 ml, stroke length: 10 mm, number of tapping: 200 times

### (4) Bulk Density

The metal composite compound was filled into the container through free fall, and the bulk density was determined from the volume of the container and the mass of the metal composite compound.

### (5) D10, D50, D90

D50, D10, and D90 were measured using a particle size distribution measurement device (MT3300EX II made by MicrotracBEL Corp.) (based on the principle of the laser diffraction scattering method). The measurement conditions of the particle size distribution measurement device are as follows. Solvent: water, refractive index of solvent: 1.33, refractive index of particles: 1.55, transmittance: 80±5%, dispersion medium: 10.0% by mass aqueous solution of sodium hexametaphosphate.

The measurement results of the specific surface area (BET specific surface area), tap density, bulk density, D10, D50, and D90 are shown in the following Table 2.

TABLE 2

| | Evaluation item | | | | | |
|---|---|---|---|---|---|---|
| | BET | | | | | |
| | specific | | | | | |
| | surface | | Bulk | | | |
| | area | Tap density | density | D10 | D50 | D90 |
| | Unit | | | | | |
| | m²/g | g/ml | g/ml | μm | μm | μm |
| Example 1 | 24.0 | 1.33 | 0.99 | 7.3 | 10.3 | 15.1 |
| Example 2 | 28.6 | 1.13 | 0.87 | 6.8 | 9.9 | 14.8 |
| Example 3 | 26.2 | 1.39 | 1.08 | 7.0 | 10.4 | 15.5 |
| Comparative | 18.9 | 1.58 | 1.23 | 6.9 | 10.0 | 14.5 |
| Example 1 | | | | | | |
| Comparative | 23.5 | 1.48 | 1.11 | 7.0 | 10.0 | 14.8 |
| Example 2 | | | | | | |

### Production of Cathode Active Material>

A lithium hydroxide powder was added to and mixed with each of the metal composite compounds of Examples 1 to 3 and Comparative Examples 1 and 2 at the molar ratio of lithium (Li) to the metal elements (M) contained in the metal composite compounds (Li/M) shown in the following Table 3 to give a mixture of the metal composite compound and lithium hydroxide. A cathode active material was produced by calcining the mixture of each of the metal composite compounds of Examples 1 and 2 and Comparative Example 1 and lithium hydroxide at a calcination temperature of 780° C. for a holding time at a calcination temperature of 780° C. of 10.0 hours, and by calcining the mixed powder of each of the metal composite compounds of Example 3 and Comparative Example 2 and lithium hydroxide at a calcination temperature of 730° C. for a holding time at a calcination temperature of 730° C. of 10.0 hours. The calcination was performed by using a box furnace in an oxygen atmosphere under conditions of a temperature-increasing rate of 120° C./hour.

For the cathode active materials prepared using the metal composite compounds of Examples 1 to 3 and Comparative Examples 1 and 2 as a precursor, the specific surface area (BET specific surface area), D10, D50, and D90 were measured using the same methods as for the metal composite compounds of Examples 1 to 3 and Comparative Examples 1 and 2. The measurement results of the specific surface area (BET specific surface area), D10, D50, and D90 of the cathode active materials are shown in the following Table 3.

### Preparation of Cathode

A cathode mixture in paste form was prepared by adding each of the cathode active materials including each of the metal composite compounds of Examples 1 to 3 and Comparative Examples 1 and 2 as a precursor, a conductive agent (acetylene black), and a binder (PVdF) to achieve a composition of cathode active material:conductive agent:biner of 92:5:3 (mass ratio), and kneading. N-methyl-2-pyrrolidone was used as an organic solvent when preparing the cathode mixture.

The obtained cathode mixture was coated onto a 15 μm-thick aluminum foil as a current collector at a basis weight of 15 mg/cm², and dried under vacuum at 150° C. for 12 hours, to obtain the cathode. The cathode was set to have an electrode area of 1.65 cm².

### Preparation of Anode

Li foil was used as the anode. The anode was set to have a thickness of 300 um and an electrode area of 1.76 cm².

### Preparation of Lithium Secondary Battery (Coin Cell)

The following operations were performed in a glovebox under a dry air atmosphere with a dew point of −70° C.

The cathode prepared in “Preparation of cathode” was placed on the coin cell cap with the aluminum foil surface facing down, and a separator (a polyethylene porous film on which a heat resistant porous layer was laminated (thickness 16 μm)) was placed thereon. Furthermore, a polypropylene (PP) gasket was installed, 300 μl of an electrolyte solution was injected thereinto, and then the anode prepared in “Preparation of anode” was bonded to a spacer and placed thereon. Subsequently, a wave washer was placed thereon, a case was put thereon, and the battery was crimped with an automatic coin cell crimping machine. The above electrolyte solution was prepared by dissolving LiPF₆ in a 30:35:35 (volume ratio) mixed solution of ethylene carbonate, dimethyl carbonate and ethyl methyl carbonate, adjusting the concentration of LiPF₆ to 1 mol/l.

### (6) Capacity Retention Rate (Cycle Characteristics)

To perform accurate capacity measurement, the cell was charged and discharged for one cycle at a charge current of 0.5 C and a discharge current of 0.2 C prior to charge-discharge. Then the charge-discharge test was performed under the conditions described below. The charge capacity and the discharge capacity in the charge-discharge test were determined as follows and the capacity retention rate was calculated based on the discharge capacity (initial discharge capacity) of the first cycle. Each test was conducted with N=2, and the average capacity retention rate was taken as the capacity retention rate of each cathode active material.

Test temperature: 25° C.
Conditions during charge: Maximum charge voltage 4.3 V, Charging time 2 hours, charge current 0.5 C, CCCV
Conditions during discharge: Minimum discharge voltage 2.5 V, Discharging time 1 hour, discharge current 1 C, CC
Number of charge-discharge: 50 times

The initial discharge capacity and the capacity retention rate of the cathode active materials are shown in the following Table 3.

TABLE 3

| | Evaluation item | | | | | | |
|---|---|---|---|---|---|---|---|
| | | BET | | | | Initial | Capacity |
| | | specific | | | | dis- | retention |
| | | surface | | | | charge | rate at |
| | Li/M | area | D10 | D50 | D90 | capacity | 50th cycle |
| | Unit | | | | | | |
| | — | m²/g | μm | μm | μm | mAh/g | % |
| Example 1 | 1.07 | 1.8 | 7.0 | 9.4 | 13.1 | 198.5 | 95.2 |
| Example 2 | 1.07 | 2.8 | 6.5 | 8.8 | 12.3 | 196.2 | 95.2 |
| Example 3 | 1.06 | 1.4 | 7.0 | 9.6 | 13.6 | 207.4 | 93.1 |
| Comparative | 1.06 | 0.7 | 7.0 | 9.5 | 13.3 | 198.0 | 92.7 |
| Example 1 | | | | | | | |
| Comparative | 1.05 | 1.2 | 6.8 | 9.2 | 12.9 | 207.1 | 90.4 |
| Example 2 | | | | | | | |

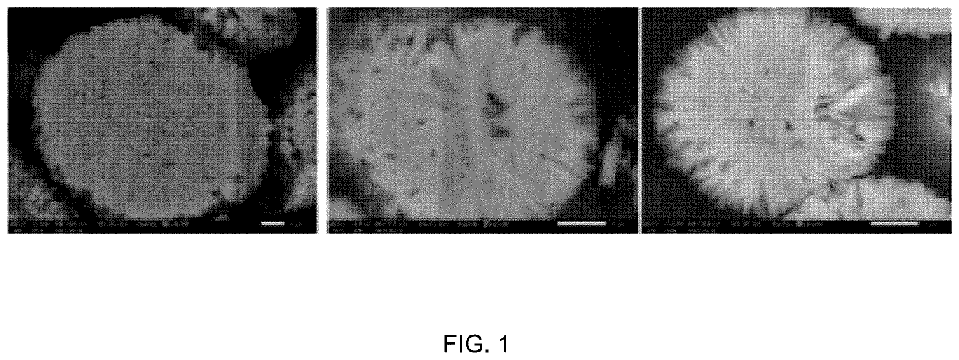

Images of a cross-section of cathode active materials prepared using each of the metal composite compounds of Comparative Example 1 and Examples 1 and 2 as a precursor obtained by a scanning electron microscope (at 20,000× magnification) are shown in FIG. 1. FIG. 1 illustrates cathode active materials prepared using each of the metal composite compounds of Comparative Example 1, Example 1, and Example 2 as a precursor from the left.

The above Tables 1 and 3 indicate that the cathode active materials of Examples 1 to 3 prepared using the metal composite compound having a β value of the fitting function Y=α×log₁₀ X+β of 300.0 or less and a boron content of 0.4 mol % to 0.9 mol % relative to the total amount of the metal elements (M) as a precursor exhibited a high capacity retention rate of 93.1 or higher, thereby preventing deterioration of cycle characteristics of the cathode active materials. In Examples 1 to 3, the α value of the fitting function Y=α×log₁₀ X+β was reduced to 38.2 or less. Furthermore, in the metal composite compounds of Examples 1 to 3, the crystallite size S2 of the (001) plane was reduced to 150.4 Å or less.

The above Table 2 indicates that in the metal composite compounds of Examples 1 to 3, the BET specific surface area was 24.0 m²/g or more, the tap density was reduced to 1.39 g/1 or less, and the bulk density was reduced to 1.08 g/ml or less.

Furthermore, as shown in FIG. 1, in the cathode active materials prepared using each of the metal composite compounds of Examples 1 and 2 as a precursor, the primary particles were small and radially arranged.

On the other hand, the above Tables 1 and 3 indicate that in the cathode active materials of Comparative Examples 1 and 2 prepared using the metal composite compound having a β value of the fitting function Y=α×log₁₀ X+β of more than 300.0 and free of boron as a precursor, the capacity retention rate was 92.7% or less and a high capacity retention rate was not achieved. Furthermore, in the metal composite compounds of Comparative Examples 1 and 2, the crystallite size S2 of the (001) plane was 155.8 Å or more.

The above Table 2 also indicates that in the metal composite compounds of Comparative Examples 1 and 2, the BET specific surface area was 23.5 m²/g or less, the tap density was 1.48 g/ml or more, and the bulk density was 1.11 g/ml or more.

Furthermore, as shown in FIG. 1, in the cathode active material prepared using the metal composite compound of Comparative Example 1 as a precursor, the primary particles were large, and radial arrangement of the primary particles was not observed.

Since the metal composite compound of the present disclosure can provide a cathode active material having a high capacity retention rate, the metal composite compound is highly valuable in secondary battery applications, particularly for devices requiring long service life.

What is claimed is:

1. A metal composite compound comprising at least nickel (Ni) and boron (B),
wherein, at a molar ratio of lithium (Li) to a metal element (M) in the metal composite compound (Li/M) of 1.01, a calcined product of the metal composite compound, maintained for a predetermined time at a calcination temperature of 730° C. in an oxygen atmosphere, exhibits a β value of 300.0 or less in a fitting function Y=α×log₁₀ X+β that is a semi-logarithmic graph of time T and a crystallite size S1, with the common logarithm of the time T (unit: minutes) for maintaining the metal composite compound at a calcination temperature of 730° C. on the X-axis and the crystallite size S1 of the (003) plane (unit: Å) on the Y-axis.

2. The metal composite compound according to claim 1, wherein a content of nickel (Ni) to the total amount of the metal element (M) is 80 mol % or more.

3. The metal composite compound according to claim 1, wherein a content of boron (B) to the total amount of the metal element (M) is more than 0 mol % and 1.0 mol % or less.

4. The metal composite compound according to claim 1, wherein an a value of Y=α×log₁₀ X+β is 40.0 or less.

5. The metal composite compound according to claim 1, wherein the metal composite compound has a crystallite size S2 of the (001) plane of 153.0 Å or less.

6. The metal composite compound according to claim 1, wherein the metal composite compound is a transition metal-containing hydroxide further comprising at least one additive element selected from the group consisting of cobalt (Co) and manganese (Mn).

7. The metal composite compound according to claim 1, wherein the metal composite compound has a BET specific surface area of 24.0 m²/g or more.

8. The metal composite compound according to claim 1, wherein the metal composite compound has a tap density of 1.50 g/ml or less.

9. The metal composite compound according to claim 1, wherein the metal composite compound has a bulk density of 1.10 g/ml or less.

10. The metal composite compound according to claim 1, wherein the metal composite compound is a precursor of a cathode active material of a non-aqueous electrolyte secondary battery.

11. A cathode active material of a non-aqueous electrolyte secondary battery, wherein the cathode active material is formed by calcining the metal composite compound according to claim 1 with a lithium compound.
